(19) United States
(12) Patent Application Publication
(10) Pub. No.: US 2024/0028004 A1
(43) Pub. Date: Jan. 25, 2024

(54) MACHINE-LEARNING DEVICE, CONTROL DEVICE, AND MACHINE-LEARNING METHOD

(71) Applicant: FANUC CORPORATION, Minamitsuru-gun, Yamanashi (JP)

(72) Inventor: Jun YAGI, Yamanashi (JP)

(21) Appl. No.: 18/028,633

(22) PCT Filed: Oct. 6, 2021
(86) PCT No.: PCT/JP2021/037047

§ 371 Date: Mar. 27, 2023

(30) Foreign Application Priority Data
Oct. 13, 2020 (JP) 2020-172337

(51) Int. Cl. G05B 19/418

(52) U.S. Cl. CPC G05B 19/41835; G05B 2219/36039

(57) ABSTRACT

A machine-learning device performs machine-learning under machining conditions including at least a waiting time of laser emission for controlling machining of a subject to be machined in a laser machining apparatus, and comprises: an action output unit which selects, as an action, a machining condition from a plurality of machining conditions, and outputs the action to the laser machining apparatus; a state acquisition unit which acquires, as state information, image data obtained by imaging a machined state of the subject that has been machined by the action; a reward calculation unit which calculates a reward on the basis of the waiting time of the laser emission and the machining accuracy of the machining state calculated on the basis of at least the acquired state information; and a learning unit which performs machine-learning on the machining conditions on the basis of the acquired state information and the calculated reward.

### TECHNICAL FIELD

The present invention relates to a machine learning device, a control device, and a machine learning method.

### BACKGROUND ART

Recently, Sustainable Development Goals (SDGs) have been established, and thus energy conservation has been an important issue in automotive, transportation, and other industries. The automotive, transportation, and other industries are therefore accelerating their efforts toward electrification and weight reduction.

For example, the use of carbon fiber reinforced plastics (CFRP) has been considered as suitable materials for weight reduction because of their light weight and high strength. However, due to their characteristics, CFRP are difficult to cut using a cutting tool (e.g., thermal effects, breaking or delamination in the material structure, and tool wear). Therefore, high-speed and high-quality laser machining is anticipated.

A known CFRP cutting technology uses an ultrashort pulsed laser (e.g., femtosecond pulsed laser with pulse widths in femto (10⁻¹⁵) seconds) and allows for reduced thermal effects in high quality machining, micromachining, ablation machining, or the like (even less thermal effects than remote cutting). See, for example, Patent Document 1.
Patent Document 1: Japanese Unexamined Patent Application, Publication No. 2017-131956

### DISCLOSURE OF THE INVENTION

### Problems to be Solved by the Invention

Incidentally, cutting using an ultrashort pulsed laser with reduced thermal effects involves a plurality of scans, because a single scan is not enough to complete the cutting. Since the same site is scanned repeatedly, it is necessary to give (wait for) a certain amount of time each time a laser scan is performed, in order to avoid a decrease in machining accuracy due to an increase in thermal effects on CFRP. Consequently, a machining time of (scan time+wait time)×number of repetitions is required, resulting in low production efficiency.

Some technologies have been therefore proposed that allow selection of optimal machining conditions, and thus indirectly lead to a reduction in scan time. However, no technologies have been proposed that reduce the machining time by minimizing the wait time.

As materials of workpieces, various types (fiber form or resin material) of CFRP have been developed depending on the intended use, and optimized machining conditions are selected for each material. This means that it is necessary to determine shortest possible wait times for a myriad of machining conditions.

It is therefore desired to reduce the machining time by minimizing the wait time while maintaining a high machining accuracy.

### Means for Solving the Problems

(1) A machine learning device according to an aspect of the present disclosure is a machine learning device for performing machine learning of machining conditions including at least laser scan wait time for controlling machining of a workpiece in a laser machine, the machine learning device including: an action output unit configured to select a machining condition as an action from among a plurality of machining conditions and output the action to the laser machine; a state acquisition unit configured to acquire, as state information, image data generated through imaging of a machining state of a workpiece machined according to the action; a reward computing unit configured to compute a reward based at least on the laser scan wait time and a machining accuracy of the machining state computed based on the state information acquired by the state acquisition unit; and a learning unit configured to perform the machine learning of the machining conditions based on the state information acquired by the state acquisition unit and the reward computed by the reward computing unit.
(2) A control device according to an aspect of the present disclosure includes: the machine learning device described in (1); and a control unit configured to control a laser machine based on the machining conditions.
(3) A machine learning method according to an aspect of the present disclosure is a machine learning method for performing machine learning of machining conditions including at least laser scan wait time for controlling machining of a workpiece in a laser machine, the machine learning method including implementation by a computer of: selecting a machining condition as an action from among a plurality of machining conditions and outputting the action to the laser machine; acquiring, as state information, image data generated through imaging of a machining state of a workpiece machined according to the action; computing a reward based at least on the laser scan wait time and a machining accuracy of the machining state computed based on the acquired state information; and performing the machine learning of the machining conditions based on the acquired state information and the computed reward.

### Effects of the Invention

According to the foregoing aspects, it is possible to reduce the machining time by minimizing the wait time while maintaining a high machining accuracy.

### BRIEF DESCRIPTION OF THE DRAWINGS

FIG. 1 is a functional block diagram illustrating an example of a functional configuration of a numerical control system according to an embodiment;

FIG. 2 is a diagram for describing the basic concept of an algorithm for reinforcement learning by an actor-critic method;

FIG. 3 is a functional block diagram illustrating an example of a functional configuration of a machine learning device;

FIG. 4 is a diagram showing examples of probability distributions of behavior policies for updated wait times;

FIG. 5 is a flowchart showing operation of the machine learning device 20 during the machine learning according to an embodiment;

FIG. 6 is a flowchart showing operation during optimized action information generation by an optimized action output unit;

FIG. 7 is a diagram showing an example of an actor-critic-based deep reinforcement learner; and

FIG. 8 is a diagram illustrating an example of a configuration of a numerical control system.

### PREFERRED MODE FOR CARRYING OUT THE INVENTION

The following describes an embodiment of the present disclosure with reference to the drawings. The present embodiment is described using, as an example, a laser machine including a femtosecond pulsed laser.

The present embodiment is also described using, as an example, a case where a laser machine (femtosecond pulsed laser) is used to perform piercing, grooving, cutting, or the like with reduced thermal effects through high quality machining, micromachining, ablation machining, or the like (also referred to below as “precision machining” for simplicity) involving a plurality of laser scans on a workpiece such as CFRP, and learning is performed upon each of predetermined specific laser scans (e.g., first, fifth, and tenth laser scans) among the plurality of laser scans. It should be noted that the present invention is also applicable to a case where learning is performed just once upon the last laser scan among the plurality of laser scans and to a case where leaning is performed upon each of the plurality of laser scans.

In the following description of the present embodiment, unless otherwise specified, a machine learning device performs machine learning each time machining of a workpiece of the same material and the same machining geometry is performed.

### First Embodiment

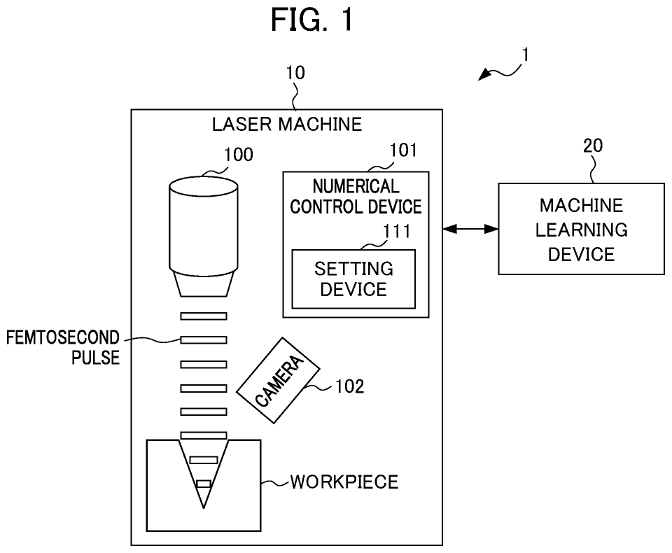

FIG. 1 is a functional block diagram illustrating an example of a functional configuration of a numerical control system according to an embodiment.

As illustrated in FIG. 1, a numerical control system 1 includes a laser machine 10 and a machine learning device 20.

The laser machine 10 and the machine learning device 20 may be directly connected to each other via a connection interface, not shown. The laser machine 10 and the machine learning device 20 may be connected to each other via a network, not shown, such as a local area network (LAN) or the Internet. In this case, the laser machine 10 and the machine learning device 20 each include a communication unit, not shown, for communicating with each other through such a connection. As described below, a numerical control device 101 is included in the machine tool 10. However, the numerical control device 101 may be separate from the machine tool 10. The numerical control device 101 may include the machine learning device 20.

The laser machine 10 is one of laser machines known to those skilled in the art and includes a femtosecond pulsed laser 100 as described above. It should be noted that the present embodiment is described using, as an example, a configuration in which the laser machine 10 includes the numerical control device 101 and operates based on operation commands from the numerical control device 101. The present embodiment is also described using, as an example, a configuration in which the laser machine 10 includes a camera 102, the camera 102 performs, based on a control instruction from the numerical control device 101 described below, imaging of the machining state of a workpiece precision-machined with the femtosecond pulsed laser 100, and image data generated through the imaging is outputted to the numerical control device 101. The numerical control device 101 and the camera 102 may be independent of the laser machine 10.

The numerical control device 101 is one of numerical control devices known to those skilled in the art and includes therein a control unit (not shown) such as a processor. The control unit (not shown) generates an operation command based on a machining program acquired from an external device (not shown) such as a CAD/CAM device and transmits the generated operation command to the laser machine 10. In this way, the numerical control device 101 controls a precision machining operation of the laser machine 10 such as high quality machining, micromachining, or ablation machining.

While controlling the operation of the laser machine 10, the numerical control device 101 may output, to the machine learning device 20 described below, machining conditions such as laser output, feed rate, and laser scan wait time in the femtosecond pulsed laser, not shown, included in the laser machine 10. The numerical control device 101 may output the machining conditions upon each of the first, fifth, and tenth laser scans among a plurality of (e.g., ten) laser scans. In other words, the numerical control device 101 may output, to the machine learning device 20 described below, machining conditions corresponding to each of mid-machining machining states of the workpiece, that is, the machining state upon the first laser scan and the machining state upon the fifth laser scan.

The numerical control device 101 causes, for precision machining of one workpiece, the femtosecond pulsed laser, not shown, to perform a plurality of (e.g., ten) laser scans on the workpiece. As such, the numerical control device 101 may cause, for example, the camera 102 to perform imaging of the machining state of the workpiece upon each of the first, fifth, and tenth laser scans. The numerical control device 101 may output, to the machine learning device 20 described below, state information of the image data generated through the imaging by the camera 102 along with the machining conditions described above.

In preparation for the precision machining of the next workpiece, a setting device 111 sets, in the laser machine 10, machining conditions including a wait time for each laser scan as an action acquired from the machine learning device 20 described below based on the most recent precision machining operation of the laser machine 10 such as high quality machining, micromachining, or ablation machining.

It should be noted that the setting device 111 may be implemented by a computer such as the control unit (not shown) of the numerical control device 101.

The setting device 111 may be separate from the numerical control device 101.

### <Machine Learning Device 20>

The machine learning device 20 performs reinforcement learning of machining conditions including laser scan wait time upon each of laser scans in precision machining of a workpiece, when the numerical control device 101 causes the laser machine 10 to operate, by executing the machining program.

Before describing each of functional blocks included in the machine learning device 20, the following first describes the basic mechanism of reinforcement learning by an actor-critic method as an example of reinforcement learning. However, as described below, the reinforcement learning is not limited to being performed by the actor-critic method.

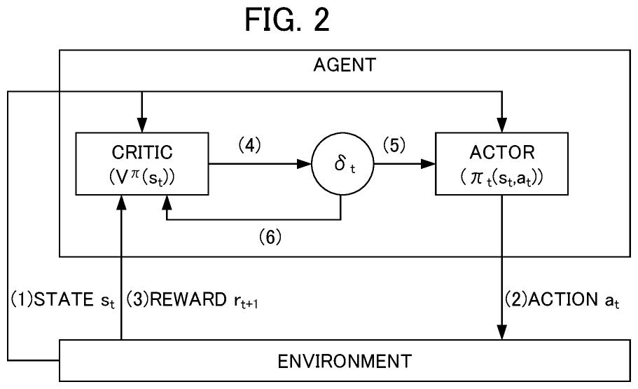

FIG. 2 is a diagram for describing the basic concept of an algorithm for the reinforcement learning by the actor-critic method.

The sequence of actor-critic interactions in the actor-critic method shown in FIG. 2 will be briefly described. (1) An actor receives a state sₜ from an environment (an agent moves to the state sₜ). (2) The agent selects an action at based on a behavior policy nₜ given to the actor. (3) After time elapses from t to t+1, a critic receives a reward rₜ₊₁ as a result of the agent taking the action aₜ. (4) The critic computes a temporal difference (TD) error using Formula 3 described below. (5) Based on a value of the TD error, the actor updates the probability distribution of the behavior policy πₜ using Formula 4 described below. (6) The critic updates a state-value function using Formula 1 described below.

More specifically, as shown in FIG. 2, the reinforcement learning by the actor-critic method has, independent of the value function, a separate structure for representing the policy. That is, the reinforcement learning by the actor-critic method is a type of TD method known to those skilled in the art that provides a reinforcement learning model with the following two separate mechanisms: an actor (actor mechanism) for selecting an action based on a behavior policy πₜ(sₜ,aₜ), and a critic (critic mechanism) for evaluating the behavior policy πₜ(sₜ,aₜ) that is currently used by the actor.

Specifically, when the state at a given time t is the state se in the reinforcement learning by the actor-critic method, for example, an update formula for the state-value function V^{π}(sₜ), which indicates how good the state se is, can be represented by Formula 1.

V^{π}(sₜ)←V^{π}(sₜ)+α[rₜ₊₁+γV^{π}(sₜ₊₁)−V^{π}(sₜ)] [Formula 1]

In this formula, γ is a discount-rate parameter and is in a range of 0<γ≤1. α is a step-size parameter (learning coefficient) and is in a range of 0<α≤1. rₜ₊₁γV^{π}(sₜ₊₁)−V^{π}(sₜ) is referred to as a TD error δₜ.

It should be noted that the update formula for the state-value function V^{π}(sₜ) can be represented by Formula 2 using an actual return Rₜ (=rₜ₊₁+γV(sₜ₊₁)) with respect to a given time t.

V^{π}(sₜ)←V^{π}(sₜ)+α[Rₜ−V^{π}(sₜ)] [Formula 2]

As represented by Formula 3, the TD error δₜ described above represents an action-value function Q^{π}(s,a) minus the state-value function V^{π}(s), which in other words is an advantage function A(s,a) that represents the value of “action only”.

δₜ=rₜ₊₁γV^{π}(sₜ₊₁)−V^{π}(sₜ)=Rₜ−V^{π}(sₜ)=A(sₜ,aₜ) [Formula 3]

In other words, in the reinforcement learning by the actor-critic method, the TD error δₜ (advantage function A(s,a)) is used to evaluate the action at taken. That is, the TD error δₜ (advantage function A(s,a)) being positive means an increase in the value of the action taken, and accordingly the tendency to select the action taken is strengthened. On the other hand, the TD error δₜ (advantage function A(s,a)) being negative means a decrease in the value of the action taken, and accordingly the tendency to select the action taken is weakened.

To this end, the probability distribution of the behavior policy πₜ(s,a) can be represented by Formula 4 using the softmax function, where the probability of the actor taking an action a in a state s is p(s,a).

$${π}_{t} ( s , a ) = \frac{{e}^{p ( s , a )}}{{Σ}_{b} {e}^{p ( s , b )}} \qquad [ Formula 4 ]$$

The actor then learns the probability p(s,a) based on Formula 5 and updates the probability distribution of the behavior policy πₜ(s,a) represented by Formula 4 to maximize the value of the state.

p(s,a)←p(s,a)+βδₜ [Formula 5]

In this formula, β is a positive step-size parameter.

The critic updates the state-value function V^{π}(sₜ) based on Formula 1.

The machine learning device 20 performs the reinforcement learning by the actor-critic method described above. Specifically, the machine learning device 20 uses, as the state Sₜ, state information of image data indicating the machining state of a workpiece generated through imaging upon a specific laser scan (e.g., first, fifth, and tenth laser scans) among a plurality of laser scans and machining conditions including a wait time for the specific laser scan, and learns the state-value function V^{π}(sₜ) and the behavior policy πₜ(sₜ,aₜ) in a case where setting/changing of the machining conditions including the wait time for the specific laser scan according to the state sₜ is selected as the action aₜ for the state sₜ.

The following describes the present embodiment using, as examples of the image data indicating the machining state of a workpiece upon a specific laser scan, image data generated through imaging after the first, fifth, and tenth laser scans among ten laser scans performed between the start of the machining and the end of the machining. The following also describes the present embodiment using, as examples of the wait time for the specific laser scan, a wait time for the first laser scan, a wait time for the fifth laser scan, and a wait time for the tenth laser scan. It should be noted that even if the number of the plurality of laser scans performed between the start of the machining and the end of the machining is not ten, and the wait times for the specific laser scans are not those for the first, fifth, and tenth laser scans, the operation of the machine learning device 20 is the same, and therefore description of such cases is omitted.

The machine learning device 20 determines actions a by observing state information (state data) s that includes image data generated through the imaging by the camera 102 after the first, fifth, and tenth laser scans, and the machining conditions including the wait times for the first, fifth, and tenth laser scans. In the machine learning device 20, a reward is received every time an action a is taken. The machine learning device 20 explores for optimal actions a in a trial-and-error manner to maximize the total reward into the future. In this way, the machine learning device 20 can select optimal actions a (i.e., “wait time for the first laser scan”, “wait time for the fifth laser scan”, and “wait time for the tenth laser scan”) for the states s that include the image data generated after the first, fifth, and tenth laser scans, and the machining conditions including the wait times for the first, fifth, and tenth laser scans.

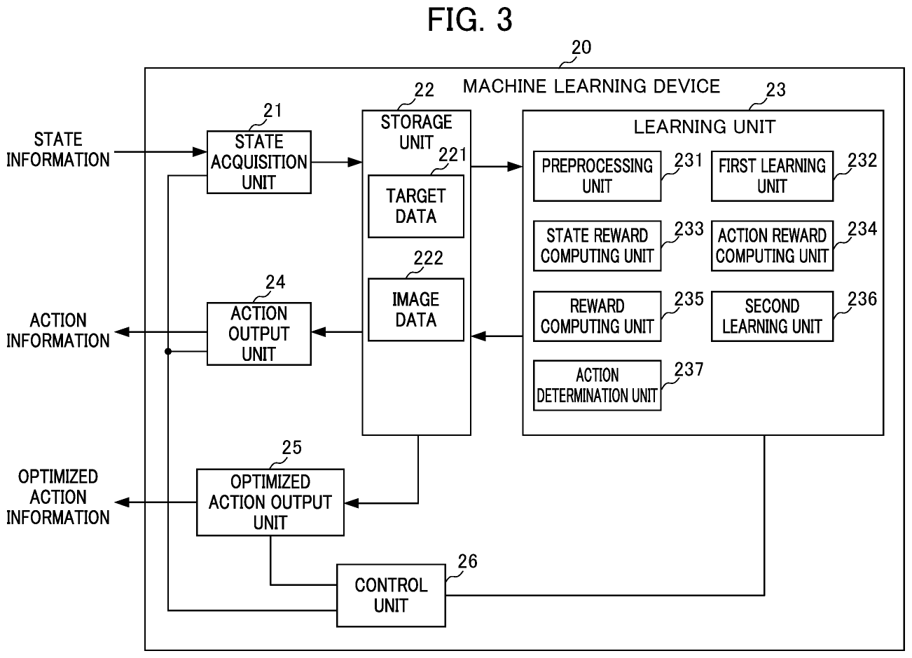

FIG. 3 is a functional block diagram illustrating an example of a functional configuration of the machine learning device 20.

In order to perform the reinforcement learning described above, the machine learning device 20 includes a state acquisition unit 21, a storage unit 22, a learning unit 23, an action output unit 24, an optimized action output unit 25, and a control unit 26 as shown in FIG. 3. The learning unit 23 includes a preprocessing unit 231, a first learning unit 232, a state reward computing unit 233, an action reward computing unit 234, a reward computing unit 235, a second learning unit 236, and an action determination unit 237. The control unit 26 controls operation of the state acquisition unit 21, the learning unit 23, the action output unit 24, and the optimized action output unit 25.

The following describes the functional blocks of the machine learning device 20. First, the storage unit 22 will be described.

The storage unit 22 is, for example, a solid state drive (SSD) or a hard disk drive (HDD), and may store therein target data 221 and image data 222 along with various control programs.

The target data 221 preliminarily contains, as machining results, image data generated through the camera 102 performing imaging of various workpieces that have been precision-machined with the laser machine 10 and that each have a target machining accuracy. The plurality of pieces of image data contained in the target data 221 are used to generate learning models (e.g., autoencoders) to be included in the first learning unit 232 described below. It should be noted that the precision machining of the workpieces with the target machining accuracy is performed with a focus on allowing adequate time for the workpieces to be well machined without caring about the machining time.

In the present embodiment, image data that is generated through imaging of the machining state of workpieces after the first, fifth, and tenth laser scans specified for the machine learning, and that has the target machining accuracy is collected in advance and stored as the target data 221 in the storage unit 22. Thus, the first learning unit 232 described below learns features contained in the image data having the target machining accuracy by applying target data to input/output. As a result, as long as image data having the target machining accuracy is inputted into an autoencoder generated by the first learning unit 232, the data can be exactly recovered. If image data that does not have the target machining accuracy is inputted, the data cannot be exactly recovered. It is therefore possible to determine whether or not the machining accuracy is satisfactory by computing the error between input data and output data as described below.

By contrast, the image data 222 is image data generated for machine learning through the camera 102 performing, after the first, fifth, and tenth laser scans, imaging of a workpiece machined with the laser machine 10 by applying each of a plurality of machining conditions including laser scan wait time. The image data 222 contains the image data in association with the machining conditions and other information.

As described above, for performing the reinforcement learning, the first learning unit 232 preliminarily generates autoencoders for computing accuracies of respective machining results, based on image data generated after the first, fifth, and tenth laser scans. The following therefore describes the function of the first learning unit 232.

The first learning unit 232 employs, for example, a technique (autoencoder) known to those skilled in the art, and preliminarily performs the machine learning for each of the image data generated after the first laser scan, the image data generated after the fifth laser scan, and the image data generated after the tenth laser scan using, as input data and output data, the image data preliminarily contained as the target data in the target data 221. Thus, the first learning unit 232 has autoencoders corresponding to the first, fifth and tenth laser scans, which are generated for each of the image data having the target machining accuracy for the first laser scan, the image data having the target machining accuracy for the fifth laser scan, and the image data having the target machining accuracy for the tenth laser scan.

As described below, the second learning unit 236 can output, to the state reward computing unit 233 described below, reconstructed images respectively based on the image data generated after the first, fifth, and tenth laser scans by inputting the image data that is generated through the imaging of the workpiece precision-machined with the laser machine 10 after the first, fifth, and tenth laser scans, and that is contained in the image data 222 in the storage unit 22 respectively into the autoencoders for the image data generated after the first, fifth, and tenth laser scans.

The state acquisition unit 21 is a functional unit responsible for (1) in the machine learning by the actor-critic method in FIG. 2. The state acquisition unit 21 acquires, from the numerical control device 101, the state data s that includes the image data indicating the machining state of the workpiece generated through the imaging by the camera 102 after the first, fifth, and tenth laser scans, and the machining conditions including the wait times for the first, fifth, and tenth laser scans. This state data s corresponds to the state s of the environment in the reinforcement learning.

The state acquisition unit 21 outputs the acquired state data s to the storage unit 22.

The learning unit 23 is a functional unit responsible for (2) to (6) in the machine learning by the actor-critic method in FIG. 2. The learning unit 23 learns the state-value function V^{π}(sₜ) and the behavior policy πₜ(sₜ,aₜ) in the reinforcement learning by the actor-critic method in a case where a given action a, is selected under the state data (environment state) sₜ at a given time t. Specifically, the learning unit 23 includes the preprocessing unit 231, the first learning unit 232, the state reward computing unit 233, the action reward computing unit 234, the reward computing unit 235, the second learning unit 236, and the action determination unit 237.

It should be noted that the learning unit 23 determines whether or not to continue the learning. The learning unit 23 can determine whether or not to continue the learning based on, for example, whether or not the trial count, which is the number of trials repeated since the start of the machine learning, has reached a maximum trial number or whether or not the time elapsed since the start of the machine learning has exceeded (or is equal to or greater than) a predetermined period of time.

In order to input the image data that is generated through the camera 102 performing imaging of the currently precision-machined workpiece after the first, fifth, and tenth laser scans, and that is contained in the image data 222 into the respective autoencoders generated by the first learning unit 232 described below, the preprocessing unit 231 performs preprocessing to convert the image data to pixel information data or to adjust the size of the image data.

The state reward computing unit 233 is a functional unit responsible for (3) in the machine learning by the actor-critic method in FIG. 2. The state reward computing unit 233 computes state rewards for actions according to the machining accuracy of the machining state indicated by the image data generated through the imaging by the camera 102 after the first, fifth, and tenth laser scans. The machining accuracy is computed based on the state information acquired by the state acquisition unit 21.

Specifically, the state reward computing unit 233 computes, for example, the error between each of the image data generated after the first laser scan, the image data generated after the fifth laser scan, and the image data generated after the tenth laser scan inputted into the respective autoencoders generated by the first learning unit 232, and the reconstructed image based on the image data. The state reward computing unit 233 computes negatives of the absolute values of the respective computed errors as state rewards r1ₛ, r2ₛ, and r3ₛ for the actions for the first, fifth, and tenth laser scans. The state reward computing unit 233 may then store the computed state rewards r1ₛ, r2ₛ, and r3ₛ in the storage unit 22. Note here that any error function may be applied to the computing of the errors.

The action reward computing unit 234 computes action rewards for actions based on at least laser scan wait times included in the actions.

Specifically, the action reward computing unit 234 computes rewards according to values of the wait times for the first, fifth, and tenth laser scans determined as actions. That is, the action reward computing unit 234 computes values of the wait times for the first, fifth, and tenth laser scans as action rewards r1ₐ, r2ₐ, and r3ₐ so that a shorter (closer to “0”) one of the wait times for the laser scans results in a better reward. The action reward computing unit 234 may then store the computed action rewards r1ₐ, r2ₐ, and r3ₐ in the storage unit 22.

The reward computing unit 235 computes a reward in a case where an action a is selected in a given state s based at least on a laser scan wait time and the machining accuracy of the machining state computed based on the state information acquired by the state acquisition unit 21.

Specifically, for example, the reward computing unit 235 computes a reward r1 by, for example, computing a weighted sum of the state reward r1ₛ for the first laser scan computed by the state reward computing unit 233 and the action reward r1ₐ computed by the action reward computing unit 234. Thus, the reward r1 reflecting effects of both the machining accuracy of the machining state and the wait time for the laser scan can be computed by computing the weighted sum of the state reward r1ₛ and the action reward r1ₐ.

Likewise, the reward computing unit 235 computes a reward r2 by computing a weighted sum of the state reward r2ₛ for the fifth laser scan computed by the state reward computing unit 233 and the action reward r2ₐ computed by the action reward computing unit 234. The reward computing unit 235 also computes a reward r3 by computing a weighted sum of the state reward r3ₛ for the tenth laser scan computed by the state reward computing unit 233 and the action reward r3ₐ computed by the action reward computing unit 234.

It should be noted that the reward computing unit 235 may compute the reward r1 by simply adding the state reward r1ₛ and the action reward r1ₐ, or using a function with the state reward r1ₛ and the action reward r1ₐ as variables. The reward computing unit 235 may also compute the reward r2 by simply adding the state reward r2ₛ and the action reward r2ₐ, or using a function with the state reward r2ₛ and the action reward r2ₐ as variables. The reward computing unit 235 may further compute the reward r3 by simply adding the state reward r3₅ and the action reward r3ₐ, or using a function with the state reward r3ₛ and the action reward r3ₐ as variables.

As described above, the second learning unit 236 is a functional unit responsible for (4) to (6) in the reinforcement learning by the actor-critic method in FIG. 2. The second learning unit 236 evaluates and updates policies based on the plurality of pieces of state information acquired by the state acquisition unit 21 and the plurality of rewards r1, r2, r3 computed by the reward computing unit 235.

Specifically, the second learning unit 236 computes, for example, a state-value function V^{π1}(s1ₜ) for a state s1ₜ after the first laser scan and a behavior policy π₁ₜ(s1ₜ,a1ₜ) for the state s1ₜ after the first laser scan. The second learning unit 236 also computes a state-value function V^{π2}(s2ₜ) for a state s2ₜ after the fifth laser scan and a behavior policy π₂ₜ(s2ₜ,a2ₜ) for the state s2ₜ after the fifth laser scan. The second learning unit 236 further computes a state-value function V^{π3}(s3ₜ) for a state s3ₜ after the tenth laser scan and a behavior policy π₃ₜ(s3ₜ,a3ₜ) for the state s3ₜ after the tenth laser scan.

The second learning unit 236 then computes the difference between a return R1 (=r1ₜ+r1ₜ₋₁+ . . . +r1₀) after the first laser scan and the computed state-value function V^{π1}(s1ₜ), which in other words is the TD error δₜ represented by Formula 3 in the state s1ₜ, as in the description of (4) in FIG. 2. As the actor, the second learning unit 236 updates the behavior policy π₂ₜ(s1ₜ,a2ₜ) according to the computed TD error δₜ in the state s1ₜ, as in the description of (5) in FIG. 2.

The second learning unit 236 also computes the difference between a return R2 (=r2ₜ+r2ₜ₋₁+ . . . +r2₀) after the fifth laser scan and the computed state-value function V^{π2}(s2ₜ), which in other words is the TD error δₜ in the state s2ₜ. As the actor, the second learning unit 236 updates the behavior policy π₂ₜ(s2ₜ,a2ₜ) according to the computed TD error δₜ in the state s2ₜ. The second learning unit 236 further computes the difference between a return R3 (=r3ₜ+r3ₜ₋₁+ . . . +r3₀) after the tenth laser scan and the computed state-value function V^{π3}(s3ₜ), which in other words is the TD error δₜ in the state s3ₜ. As the actor, the second learning unit 236 updates the behavior policy π₃ₜ(s³ₜ,a3ₜ) according to the computed TD error δₜ in the state s3ₜ.

As the critic, the second learning unit 236 updates the state-value function V^{π1}(s1ₜ) according to the computed TD error δₜ in the state s1ₜ, as in the description of (6) in FIG. 2. As the critic, the second learning unit 236 also updates the state-value function V^{π2}(s2ₜ) according to the computed TD error δₜ in the state s2ₜ. As the critic, the second learning unit 236 further updates the state-value function V^{π3}(s3ₜ) according to the computed TD error δₜ in the state s3ₜ.

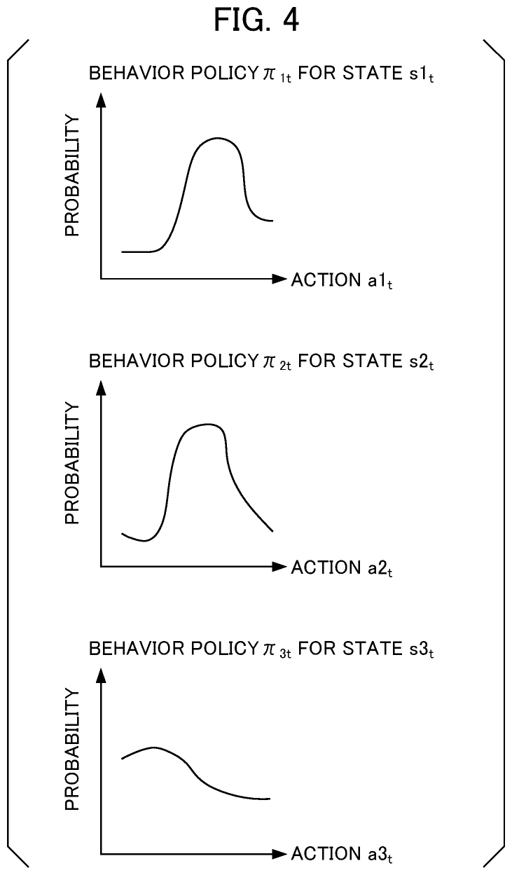

FIG. 4 is a diagram showing examples of probability distributions of the behavior policies π₁ₜ(s1ₜ,a1ₜ), π₂ₜ(s2ₜ,a2ₜ), and π₃ₜ(s3ₜ,a3ₜ) for the updated wait times.

Although FIG. 4 shows the probability distributions of the behavior policies for wait time, the second learning unit 236 may update probability distributions of behavior policies for each of wait time, laser output, feed rate, and the like included in the machining conditions, or may update a single distribution for wait time, laser output, feed rate, and the like included in the machining conditions all together.

The action determination unit 237 is a functional unit responsible for (2) in the machine learning by the actor-critic method in FIG. 2. The action determination unit 237 determines actions a1ₜ, a2ₜ, and a3ₜ respectively based on the improved stochastic policies π₁ₜ(s1ₜ,a1ₜ), π₂ₜ(s2ₜ,a2ₜ), and π₃ₜ(s3ₜ,a3ₜ) respectively corresponding to the state s1ₜ after the first laser scan, the state s2ₜ after the fifth laser scan, and the state s3ₜ after the tenth laser scan. The action determination unit 237 stores the thus determined actions alt, a2ₜ, and a3ₜ in the storage unit 22. Then, the action output unit 24 described below acquires the actions a1ₜ, a2ₜ, and a3ₜ from the storage unit 22.

Specifically, the action determination unit 237 determines, for example, the actions a1ₜ, a2ₜ, and a3ₜ respectively based on the probability distributions of the respective updated behavior policies π₁ₜ(s1ₜ,a1ₜ), π₂ₜ(s2ₜ,a2ₜ), and r3ₜ(s3ₜ,a3ₜ) shown in FIG. 4.

The action output unit 24 is a functional unit responsible for (2) in the machine learning by the actor-critic method in FIG. 2. The action output unit 24 outputs, to the laser machine 10, the actions a1ₜ, a2ₜ, and a3ₜ outputted from the learning unit 23. The action output unit 24 may, for example, output the machining conditions including values of the “wait time for the first laser scan”, the “wait time for the fifth laser scan”, and the “wait time for the tenth laser scan” that have been updated, as action information to the laser machine 10. The numerical control device 101 then controls the operation of the laser machine 10 based on the machining conditions including the “wait time for the first laser scan”, the “wait time for the fifth laser scan”, and the “wait time for the tenth laser scan” that have been received and updated.

The optimized action output unit 25 outputs the machining conditions including the values of the “wait time for the first laser scan”, the “wait time for the fifth laser scan”, and the “wait time for the tenth laser scan” to the laser machine 10 based on the results of the learning by the learning unit 23.

Specifically, the optimized action output unit 25 acquires the behavior policy π₁ₜ(s1ₜ,a1ₜ), the behavior policy π₂ₜ(s2ₜ,a2ₜ), and the behavior policy π₃ₜ(s3ₜ,a3ₜ) stored in the storage unit 22. As described above, the behavior policy π₁ₜ(s1ₜ,a1ₜ), the behavior policy π₂ₜ(s2ₜ,a2ₜ), and the behavior policy π₃ₜ(s3ₜ,a3ₜ) are updated behavior policies resulting from the machine learning performed by the second learning unit 236. The optimized action output unit 25 then generates action information based on the behavior policy π₁ₜ(s1ₜ,a1ₜ), the behavior policy π₂ₜ(s2ₜ,a2ₜ), and the behavior policy π₃ₜ(s3ₜ,a3ₜ), and outputs the generated action information to the laser machine 10. This optimized action information includes information indicating the values of the “wait time for the first laser scan”, the “wait time for the fifth laser scan”, and the “wait time for the tenth laser scan” that have been improved, as in the case of the action information outputted by the action output unit 24.

The functional blocks included in the machine learning device 20 have been described above.

The machine learning device 20 includes an arithmetic processor such as a CPU to implement these functional blocks. The machine learning device 20 also includes an auxiliary storage device such as an HDD that stores therein various control programs such as application software and an operating system (OS), and a main storage device such as random access memory (RAM) that stores therein data temporarily needed for the arithmetic processor to execute the programs.

In the machine learning device 20, the arithmetic processor reads the application software and the OS from the auxiliary storage device, and performs arithmetic processing based on the application software and the OS while deploying the read application software and OS into the main storage device. Various hardware components of the machine learning device 20 are controlled based on the results of the arithmetic processing. Through the above, the functional blocks according to the present embodiment are implemented. That is, the present embodiment can be implemented through cooperation of hardware and software.

Since machine learning is computationally intensive, the machine learning device 20 can preferably achieve high-speed processing, for example, by incorporating a graphics processing unit (GPU) in a personal computer and using the GPU for the arithmetic processing involved in the machine learning through a technique referred to as general-purpose computing on graphics processing units (GPGPU). Furthermore, for higher-speed processing, a computer cluster may be built using a plurality of computers each having the GPU, and parallel processing may be performed using the plurality of computers included in the computer cluster.

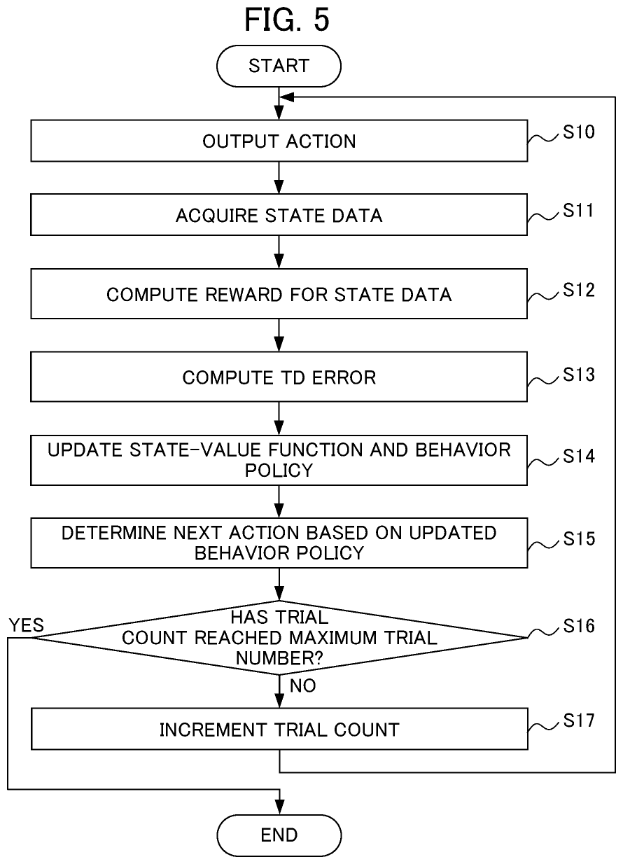

Referring to the reinforcement learning by the actor-critic method in FIG. 2 and the flowchart in FIG. 5, the following now describes operation of the machine learning device 20 during the machine learning according to the present embodiment.

FIG. 5 is a flowchart showing the operation of the machine learning device 20 during the machine learning according to an embodiment. As described above, based on the image data generated after the first, fifth, and tenth laser scans, the first learning unit 232 preliminarily generates the autoencoders for computing the accuracy of the respective machining results.

In Step S10, the action output unit 24 outputs an action to the laser machine 10 as in the description of (2) in FIG. 2.

In Step S11, as in the description of (1) in FIG. 2, the state acquisition unit 21 acquires the following as the state of the laser machine 10 from the numerical control device 101: the state data s1ₜ that includes the image data generated through the imaging by the camera 102 of the laser machine 10 after the first laser scan and the machining conditions including the wait time for the laser scan; the state data s2ₜ that includes the image data generated after the fifth laser scan and the machining conditions including the wait time for the laser scan; and the state data s3ₜ that includes the image data generated after the tenth laser scan and the machining conditions including the wait time for the laser scan.

In Step S12, as in the description of (3) in FIG. 2, the reward computing unit 235 computes the rewards r1, r2, and r3 in the cases where actions are selected under the state data s1ₜ, s2ₜ, and s3ₜ, respectively, based on the wait times for the laser scans, and the machining accuracy of the machining state computed based on the state data s1ₜ, s2ₜ, and s3ₜ acquired in Step S11.

Specifically, the second learning unit 236 inputs the image data corresponding to the state data s1ₜ, s2ₜ, and s3ₜ acquired in Step S11 respectively into the autoencoders generated by the first learning unit 232, and outputs reconstructed images respectively based on the image data corresponding to the state data s1ₜ, s2ₜ, and s3ₜ. The state reward computing unit 233 computes the error between each of the inputted image data corresponding to the state data s1ₜ, the inputted image data corresponding to the state data s2ₜ, and the inputted image data corresponding to the state data s3ₜ, and the outputted reconstructed image based on the image data. The state reward computing unit 233 then computes negatives of the absolute values of the respective computed errors as the state rewards r1ₛ, r2ₛ, and r3ₛ for the state data s1ₜ, s2ₜ, and s3ₜ. The action reward computing unit 234 computes values of the wait times for the laser scans as the action rewards r1ₐ, r2ₐ, and r3ₐ so that a shorter (closer to “0”) one of the wait times corresponding to the state data s1ₜ, s2ₜ, and s3ₜ results in a better reward. Then, the reward computing unit 235 computes the rewards r1ₜ, r2ₜ, and r3ₜ by computing a weighted sum of the state reward r1ₛ computed by the state reward computing unit 233 and the action reward r1ₐ computed by the action reward computing unit 234 for the state data s1ₜ, a weighted sum of the state reward r2ₛ and the action reward r2ₐ for the state data s2ₜ, and a weighted sum of the state reward r3ₛ and the action reward r3ₐ for the state data s3ₜ.

In Step S13, the second learning unit 236 computes the state-value functions V^{π1}(s1^{t}), V^{π2}(s2^{t}), and Vⁿ³(s3^{t}), and the behavior policies π^{1t}(s1^{t},a1^{t}), π^{2t}(s2^{t},a2^{t}), and π^{3t}(s3^{t},a3^{t}) for the respective states (state data) s1^{t}, s2^{t}, and s3^{t}. Then, as in the description of (4) in FIG. 2, the second learning unit 236 computes the difference between the return R1 in the state (state data) s1ₜ and the computed state-value function V^{π1}(s1ₜ) as the TD error δₜ in the state (state data) s1l, the difference between the return R2 in the state (state data) s2ₜ and the computed state-value function V^{π2}(s2ₜ) as the TD error δₜ in the state (state data) s2ₜ, and the difference between the return R3 in the state (state data) s3ₜ and the computed state-value function V^{π3}(s3ₜ) as the TD error δₜ in the state (state data) s3ₜ.

In Step S14, as the actor, the second learning unit 236 updates the behavior policies π₁ₜ(s1ₜ,a1ₜ), π₂ₜ(s2ₜ,a2ₜ), and π₃ₜ(s3ₜ,a3ₜ) according to the TD errors δₜ in the respective states (state data) s1ₜ, s2ₜ, and s3ₜ computed in Step S13, as in the description of (5) in FIG. 2. As the critic, the second learning unit 236 also updates the state-value functions V^{π1}(s1ₜ), V^{π2}(s2ₜ), and V^{π3}(s3ₜ) according to the TD errors δₜ in the respective states (state data) s1ₜ, s2ₜ, and s3ₜ computed in Step S13, as in the description of (6) in FIG. 2.

In Step S15, as in the description of (2) in FIG. 2, the action determination unit 237 determines the actions alt, a2ₜ, and a3ₜ respectively based on the updated stochastic policies π^{1t}(s1ₜ,a1ₜ), r2ₜ(s2ₜ,a2ₜ), and r3ₜ (s3ₜ,a3ₜ) respectively corresponding to the state s1ₜ after the first laser scan, the state s2ₜ after the fifth laser scan, and the state s3ₜ after the tenth laser scan.

In Step S16, the learning unit 23 determines whether or not the trial count, which is the number of trials repeated since the start of the machine learning, has reached the maximum trial number. The maximum trail number is a preset number. If the trial count has reached the maximum trial number, the processing ends. If the trial count has not reached the maximum trial number, the processing continues to Step S17.

In Step S17, the learning unit 23 increments the trial count, and the processing returns to Step S10.

In the flow in FIG. 5, the processing is terminated once the trial count has reached the maximum trial number. Alternatively, the amount of time taken for the processes in Steps S10 to S16 may be accumulated, and the processing may be terminated on condition that the amount of time accumulated since the start of the machine learning has exceeded (or is equal to or greater than) a preset maximum elapsed time.

According to the present embodiment, through the operation described above with reference to FIG. 5, it is possible to generate the behavior policies π₁ₜ(s1ₜ,a1ₜ), π₂ₜ(s2ₜ,a2ₜ), and π₃ₜ(s3ₜ,a3ₜ) for generating action information to be used to reduce the machining time by minimizing the wait time while maintaining a high machining accuracy.

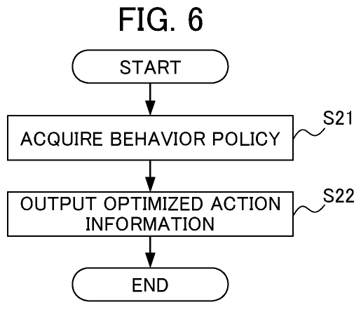

Referring to the flowchart in FIG. 6, the following describes operation during optimized action information generation by the optimized action output unit 25.

In Step S21, the optimized action output unit 25 acquires the behavior policies π₁ₜ(s1ₜ,a1ₜ), π₂ₜ(s2ₜ,a2ₜ), and π₃ₜ(s3ₜ,a3ₜ) stored in the storage unit 22. The behavior policies π₁ₜ(s1ₜ,a1ₜ), π₂ₜ(s2ₜ,a2ₜ), and π₃ₜ (s3ₜ,a3ₜ) are updated behavior policies resulting from the reinforcement learning by the actor-critic method performed by the learning unit 23 as described above.

In Step S22, the optimized action output unit 25 generates optimized action information based on the behavior policies π₁ₜ(s1ₜ,a1ₜ), π₂ₜ(s2ₜ,a2ₜ), and π₃ₜ(s3ₜ,a3ₜ), and outputs the generated optimized action information to the laser machine 10.

As described above, the machine learning device 20 can reduce the machining time by minimizing the wait time while maintaining a high machining accuracy.

Although an embodiment has been described above, the machine learning device 20 is not limited to the foregoing embodiment, and encompasses changes such as modifications and improvements to the extent that the object of the present disclosure is achieved.

### Modification Example 1

The foregoing embodiment has been described using, as an example, the machine learning device 20 that is separate from the numerical control device 101. However, the numerical control device 101 may have some or all of the functions of the machine learning device 20.

Alternatively, a server, for example, may have some or all of the state acquisition unit 21, the learning unit 23, the action output unit 24, the optimized action output unit 25, and the control unit 26 of the machine learning device 20. Furthermore, each of the functions of the machine learning device 20 may be implemented using, for example, a virtual server function on a cloud.

Furthermore, the machine learning device 20 may be a distributed processing system in which the functions of the machine learning device 20 are distributed among a plurality of servers as appropriate.

### Modification Example 2

For another example, the machine learning device 20 according to the foregoing embodiment observes three pieces of state data, that is, state data after the first, fifth, and tenth laser scans, but the machine learning device 20 is not limited as such. For example, the machine learning device 20 may observe one piece of state data or two or more pieces of state data.

In a configuration in which the machine learning device 20 observes one piece of state data, for example, the machine learning device 20 may observe, as the state data s1ₜ, image data generated after the tenth laser scan after all the scans performed by the laser machine 10, and machining conditions including a wait time for the laser scan. Thus, the machine learning device 20 can reduce the machining time by minimizing the wait time on a workpiece-by-workpiece basis.

### Modification Example 3

For another example, the machine learning device 20 (second learning unit 236) according to the foregoing embodiment employs reinforcement learning by the actor-critic method, but the machine learning device 20 is not limited as such. For example, the machine learning device 20 (second learning unit 236) may implement deep learning to apply the actor-critic method to. For the deep learning by the actor-critic method, an actor-critic-based deep reinforcement learner may be used that adopts a neural network, such as Advantage Actor-Critic (A2C) or Asynchronous Advantage Actor-Critic (A3C) known to those skilled in the art. Detailed description of A2C and A3C is available in the following non-patent document, for example.

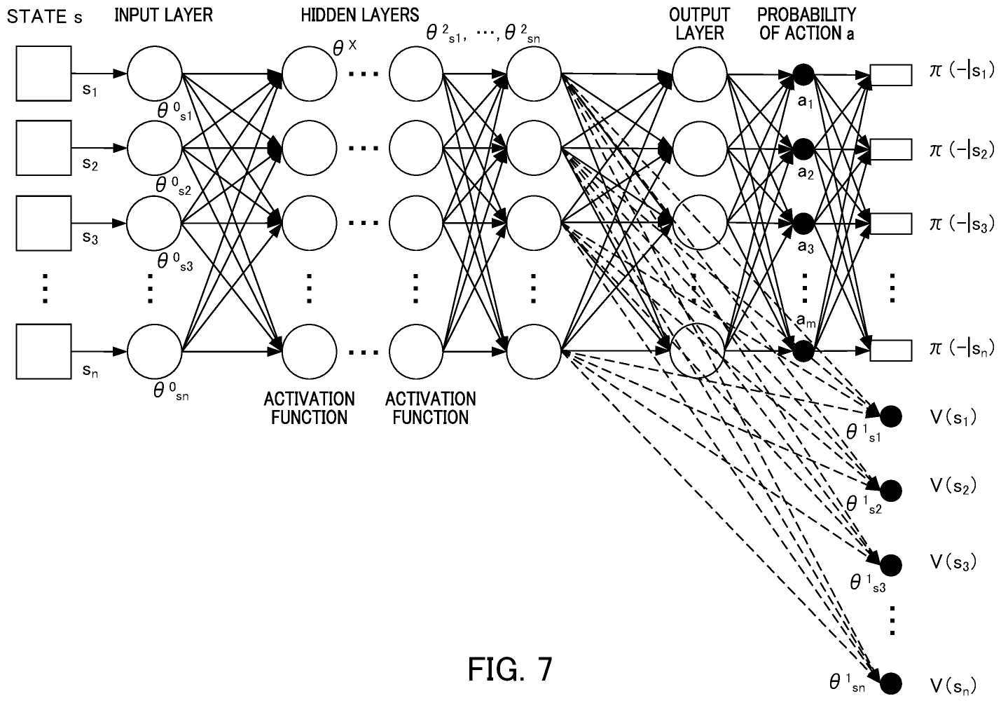

FIG. 7 is a diagram showing an example of the actor-critic-based deep reinforcement learner.

As shown in FIG. 7, the actor-critic-based deep reinforcement learner includes: an actor that inputs states s₁ to sₙ of preprocessed image data (state data) from the image data 222 and outputs an advantage function value (TD error δₜ) for each of actions a₁ to aₘ; and a critic that outputs state-value functions V(s) (n and m are positive integers). The actor of the actor-critic-based deep reinforcement learner may convert the outputted advantage function value (TD error δₜ) into a probability using the softmax function and save the distribution thereof as a stochastic policy in the storage unit 22.

It should be noted that weights θ¹ₛ₁ to θ¹ₛₙ are parameters for computing the state value functions V(s) for the respective states s₁ to sₙ, and update amounts dθ¹ₛ₁ to dθ¹ₛₙ of the weights θ¹ₛ₁ to θ¹ₛₙ are gradients determined using “squared errors of advantage functions” based on a gradient descent method. Weights θ²ₛ₁ to θ²ₛₙ are parameters for computing behavior policies π(s,a) for the respective states s₁ to sₙ, and update amounts dθ²ₛ₁ to dθ²ₛₙ of the weights θ²ₛ₁ to θ²ₛₙ are gradients of “policies×advantage functions” based on a policy gradient method.

### Non-Patent Document

“Asynchronous Methods for Deep Reinforcement Learning” by Volodymyr Mnih, [online]<URL: https://arxiv.org/pdf/1602.01783.pdf>

### Modification Example 4

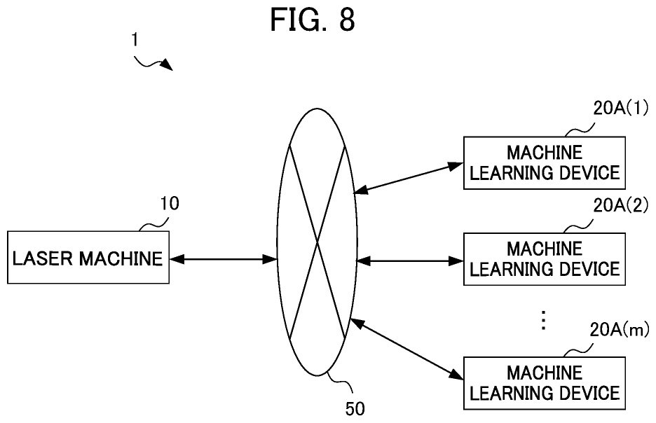

For another example, the numerical control system 1 according to the foregoing embodiment includes a single laser machine 10 and a single machine learning device 20 that are communicatively connected to each other, but the numerical control system 1 is not limited as such. For example, as shown in FIG. 8, the control system 1 may include a single laser machine 10 and m machine learning devices 20A(1) to 20A(m) that are connected to each other via a network 50 (m is an integer equal to or greater than 2). In this case, the target data 221 and the image data 222 stored in the storage unit 22 of a machine learning device 20A(j) may be shared with another machine learning device 20A(k) (j and k are integers from 1 to m, k≠j). A configuration in which the target data 221 and the image data 222 are shared among the machine learning devices 20A(1) to 20A(m) allows reinforcement learning responsibilities to be distributed among the machine learning devices 20A, improving the efficiency of the reinforcement learning.

It should be noted that each of the machine learning devices 20A(1) to 20A(m) is equivalent to the machine learning device 20 in FIG. 1.

### Modification Example 5

For another example, the machine learning device 20 according to the foregoing embodiment is applied to precision machining with the laser machine 10 such as piercing, grooving, or cutting through high quality machining, micromachining, ablation machining, or the like involving a plurality of laser scans on a workpiece such as CFRP, but the machine learning device 20 is not limited as such. For example, the machine learning device 20 may be applied to a laser additive manufacturing process with the laser machine 10, in which laser is irradiated through a galvanometer mirror onto a bed of metal powder to melt and solidify (or sinter) the metal powder only in the irradiated area, and the irradiation is repeated to form layers, thereby generating a structure having a complex three-dimensional shape. In this case, the machining conditions may include post-layer formation wait time instead of the laser scan wait time, along with other conditions such as scan intervals and layer thickness.

### Modification Example 6

For another example, the machine learning device 20 (second learning unit 236) according to the foregoing embodiment employs reinforcement learning by the actor-critic method, but the machine learning device 20 is not limited as such. For example, the machine learning device 20 (second learning unit 236) may employ Q-learning, which is a technique to learn an action-value function Q(s,a) for selecting an action a in a given state s of an environment.

The objective of Q-learning is to select, as an optimal action, an action a with the highest value of the action-value function Q(s,a) among actions a that can be taken in a given state s.

However, at the initial start of Q-learning, a right value of the action-value function Q(s,a) with respect to the combination of the state s and the action a is completely unknown. The agent therefore progressively learns the right action-value function Q(s,a) by selecting a variety of actions a in a given state s and selecting a better action from among the variety of actions a based on rewards given.

In pursuit of a goal to maximize the total reward to be received into the future, Q-learning ultimately aims to achieve Q(s,a)=E[Σ(γ^{t})r₁]. In this equation, E[ ] represents an expected value, where t is time, γ is a discount-rate parameter, which will be described below, rₜ is a reward at time t, and Σ is a sum by time t. The expected value in this equation is a value expected in a case where the state changes according to an optimal action. However, the optimal action is unknown in the process of Q-learning, and therefore reinforcement learning is performed through exploration involving taking a variety of actions. An update formula for the action-value function Q(s,a) can be, for example, represented by Formula 6 shown below.

$$Q ( {s}_{t + 1} , {a}_{t + 1} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad [ Formula 6 ]$$

In Formula 6 shown above, sₜ represents a state of the environment at time t, and aₜ represents an action at time t. The state changes to sₜ₊₁ according to the action aₜ. rₜ₊₁ represents a reward that is received according to the state change. The term with max represents the product of γ and a Q value in a case where an action a with the highest Q value of all known at the time is selected in the state sₜ₊₁. Note here that γ is a discount-rate parameter and is in a range of 0<γ≤1. α is a step-size parameter (learning coefficient) and is in a range of 0<α≤1.

Formula 6 shown above represents a process to update an action-value function Q(sₜ,aₜ) of the action aₜ in the state se based on the reward rₜ₊₁ received as a result of the trial aₜ.

This update formula indicates that the action-value function Q(sₜ,aₜ) is increased if the value maxₐ Q(sₜ₊₁,a) of an optimal action in the next state sₜ₊₁ according to the action aₜ is greater than the Q(sₜ,aₜ) of the action at in the state sₜ, and conversely, the Q(sₜ,aₜ) is decreased if the value maxₐ Q(sₜ₊₁,a) is smaller. That is, the value of a given action in a given state is brought toward the value of the optimal action in the next state according to the given action. Although the difference therebetween varies depending on presence of the discount-rate parameter γ and the reward rₜ₊₁, basically, it is designed to propagate the value of an optimal action in a given state to the value of an action in the immediately prior state leading to the optimal action.

Note here that a certain Q-learning method involves creating a table of Q(s,a) for all state-action pairs (s,a) for learning. However, the number of states can be so large that determining Q(s,a) values for all the state-action pairs consumes too much time. In such a case, Q-learning takes a significant amount of time to converge.

To address this issue, a known technique referred to as Deep Q-Network (DQN) may be employed. Specifically, an action-value function Q may be built using an appropriate neural network, and values of the action-value function Q(s,a) may be computed by approximating the action-value function Q by the appropriate neural network by adjusting parameters of the neural network. The use of DQN makes it possible to reduce the time required for Q-learning to converge. Detailed description of DQN is available in the following non-patent document, for example.

### Non-Patent Document

“Human-level control through deep reinforcement learning”, by Volodymyr Mnih [online], [searched on Jan. 17, 2017], Internet <URL: http://files.davidqiu.com/research/nature14236.pdf>

It should be noted that each of the functions included in the machine learning device 20 according to the foregoing embodiment can be implemented by hardware, software, or a combination thereof. Being implemented by software herein means being implemented through a computer reading and executing a program.

Each of the components of the machine learning device 20 can be implemented by hardware including electronic circuitry or the like, software, or a combination thereof. In the case where the machine learning device 20 is implemented by software, programs that constitute the software are installed on a computer. These programs may be distributed to users by being recorded on removable media or may be distributed by being downloaded onto users' computers via a network. In the case where the machine learning device 20 is implemented by hardware, some or all of the functions of the components included in the device can be constituted, for example, by an integrated circuit (IC) such as an application specific integrated circuit (ASIC), a gate array, a field programmable gate array (FPGA), or a complex programmable logic device (CPLD).

The programs can be supplied to the computer by being stored on any of various types of non-transitory computer readable media. The non-transitory computer readable media include various types of tangible storage media. Examples of non-transitory computer readable media include magnetic storage media (such as flexible disks, magnetic tape, and hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM), erasable PROM (EPROM), flash ROM, and RAM). Alternatively, the programs may be supplied to the computer using any of various types of transitory computer readable media. Examples of transitory computer readable media include electrical signals, optical signals, and electromagnetic waves. Such transitory computer readable media are able to supply the programs to the computer through a wireless communication channel or a wired communication channel such as electrical wires or optical fibers.

It should be noted that writing the programs to be recorded on a storage medium includes processes that are not necessarily performed chronologically and that may be performed in parallel or individually as well as processes that are performed chronologically according to the order thereof.

To put the foregoing into other words, the machine learning device, the control device, and the machine learning method according to the present disclosure can take various embodiments having the following configurations.
(1) A machine learning device 20 according to the present disclosure is a machine learning device for performing machine learning of machining conditions including at least laser scan wait time for controlling machining of a workpiece in a laser machine 10, the machine learning device 20 comprising: an action output unit 24 configured to select a machining condition as an action from among a plurality of machining conditions and output the action to the laser machine 10; a state acquisition unit 21 configured to acquire, as state information, image data generated through imaging of a machining state of a workpiece machined according to the action; a reward computing unit 235 configured to compute a reward based at least on the laser scan wait time and a machining accuracy of the machining state computed based on the state information acquired by the state acquisition unit 21; and a learning unit 23 configured to perform the machine learning of the machining conditions based on the state information acquired by the state acquisition unit 21 and the reward computed by the reward computing unit 235.

This machine learning device 20 can reduce the machining time by minimizing the wait time while maintaining a high machining accuracy.
(2) In the machine learning device 20 described in (1), the machining state may include one or more mid-machining machining states between the start of the machining and the end of the machining, and the machining condition may include machining conditions corresponding to the mid-machining machining states respectively.

This configuration enables the machine learning device 20 to increase the machining accuracy.
(3) The machine learning device 20 described in (1) or (2) may further include: a state reward computing unit 233 configured to compute a state reward for the action according to the machining accuracy of the machining state computed based on the state information acquired by the state acquisition unit 21; and an action reward computing unit 234 configured to compute an action reward for the action based on at least the laser scan wait time included in the action. The reward computing unit 235 may compute the reward for the action based on the state reward and the action reward.

This configuration enables the machine learning device 20 to accurately compute a reward according to the machining accuracy and the laser scan wait time.
(4) In the machine learning device 20 described in (3), the state reward computing unit 233 may compute the machining accuracy of the machining state based on reconstructed image data outputted by inputting the state information acquired by the state acquisition unit 21 into an autoencoder trained based only on image data generated through imaging of machining states of workpieces each having a high machining accuracy.

This configuration enables the machine learning device 20 to accurately compute a state reward according to the machining accuracy.
(5) In the machine learning device 20 described in any one of (1) to (4), the action output unit 24 may output an action to the laser machine 10 based on a policy for selecting one machining condition as an action from among a plurality of machining conditions, and the learning unit 23 may evaluate and improve the policy based on a plurality of pieces of the state information acquired by the state acquisition unit 21 and a plurality of action rewards computed by the reward computing unit 235.

This configuration enables the machine learning device 20 to select an optimal action.
(6) The machine learning device 20 described in any one of (1) to (5) may further include an optimized action output unit configured to output the machining conditions to the laser machine 10 based on a result of the learning by the learning unit 23.

This configuration enables the machine learning device 20 to output optimal machining conditions.
(7) The machine learning device 20A described in any one of (1) to (6) may include a plurality of the machine learning devices 20A. The machine learning of the machining conditions may be distributed and performed among the plurality of machine learning devices 20A via a network 50.

This configuration enables the machine learning device 20A to improve the efficiency of the reinforcement learning.
(8) In the machine learning device 20 described in any one of (1) to (7), the learning unit 23 may perform reinforcement learning by an actor-critic method.

This configuration enables the machine learning device 20 to reduce the machining time by minimizing the wait time more accurately.
(9) A numerical control device 101 according to the present disclosure includes: the machine learning device 20 described in any one of (1) to (8); and a control unit configured to control the laser machine 10 based on the machining conditions.

This numerical control device 101 can produce the same effects as those described in (1).
(10) A machine learning method according to the present disclosure is a machine learning method for performing machine learning of machining conditions including at least laser scan wait time for controlling machining of a workpiece in a laser machine 10. The machine learning method includes implementation by a computer of: selecting a machining condition as an action from among a plurality of machining conditions and outputting the action to the laser machine 10; acquiring, as state information, image data generated through imaging of a machining state of a workpiece machined according to the action; computing a reward based at least on the laser scan wait time and a machining accuracy of the machining state computed based on the acquired state information; and performing the machine learning of the machining conditions based on the acquired state information and the computed reward.

This machine learning method can produce the same effects as those described in (1).

### EXPLANATION OF REFERENCE NUMERALS

1: Numerical control system
10: Laser machine
101: Numerical control device
102: Camera
20: Machine learning device
21: State acquisition unit
22: Storage unit
23: Learning unit
231: Preprocessing unit
232: First learning unit
233: State reward computing unit
234: Action reward computing unit
235: Reward computing unit
236: Second learning unit
237: Action determination unit
24: Action output unit
25: Optimized action output unit

1. A machine learning device for performing machine learning of machining conditions including at least laser scan wait time for controlling machining of a workpiece in a laser machine, the machine learning device comprising:
an action output unit configured to select a machining condition as an action from among a plurality of machining conditions and output the action to the laser machine;
a state acquisition unit configured to acquire, as state information, image data generated through imaging of a machining state of a workpiece machined according to the action;
a reward computing unit configured to compute a reward based at least on the laser scan wait time and a machining accuracy of the machining state computed based on the state information acquired by the state acquisition unit; and
a learning unit configured to perform the machine learning of the machining conditions based on the state information acquired by the state acquisition unit and the reward computed by the reward computing unit.

2. The machine learning device according to claim 1, wherein the machining state includes one or more mid-machining machining states between a start of the machining and an end of the machining, and the machining condition includes machining conditions corresponding to the mid-machining machining states respectively.

3. The machine learning device according to claim 1, further comprising:
a state reward computing unit configured to compute a state reward for the action according to the machining accuracy of the machining state computed based on the state information acquired by the state acquisition unit; and
an action reward computing unit configured to compute an action reward for the action based on at least the laser scan wait time included in the action, wherein
the reward computing unit computes the reward for the action based on the state reward and the action reward.

4. The machine learning device according to claim 3, wherein the state reward computing unit computes the machining accuracy of the machining state based on reconstructed image data outputted by inputting the state information acquired by the state acquisition unit into an autoencoder trained based only on image data generated through imaging of machining states of workpieces each having a high machining accuracy.

5. The machine learning device according to claim 1, wherein
the action output unit outputs an action to the laser machine based on a policy for selecting one machining condition as an action from among a plurality of machining conditions, and
the learning unit evaluates and improves the policy based on a plurality of pieces of the state information acquired by the state acquisition unit and a plurality of action rewards computed by the reward computing unit.

6. The machine learning device according to claim 1, further comprising an optimized action output unit configured to output the machining conditions to the laser machine based on a result of the learning by the learning unit.

7. The machine learning device according to claim 1, comprising a plurality of the machine learning devices, wherein the machine learning of the machining conditions is distributed and performed among the plurality of machine learning devices via a network.

8. The machine learning device according to claim 1, wherein the learning unit performs reinforcement learning by an actor-critic method.

9. A control device comprising:
the machine learning device according to claim 1; and
a control unit configured to control the laser machine based on the machining conditions.

10. A machine learning method for performing machine learning of machining conditions including at least laser scan wait time for controlling machining of a workpiece in a laser machine, the machine learning method comprising implementation by a computer of:
selecting a machining condition as an action from among a plurality of machining conditions and outputting the action to the laser machine;
acquiring, as state information, image data generated through imaging of a machining state of a workpiece machined according to the action;
computing a reward based at least on the laser scan wait time and a machining accuracy of the machining state computed based on the acquired state information; and
performing the machine learning of the machining conditions based on the acquired state information and the computed reward.
